(19) United States
(12) Patent Application Publication
(10) Pub. No.: US 2010/0110704 A1
(43) Pub. Date: May 6, 2010

(54) Extensible harps

(75) Inventor: Gary Hui Hui, Kowloon (CN)

Correspondence Address: DENNIS B. HAASE, P.O. BOX 6206, HOT SPRINGS, AR, 71902-6206, US

(73) Assignee: Mastercraft International USA, Inc.

(21) Appl. No.: 12/290,919

(22) Filed: Nov. 6, 2008

(51) Int. Cl. F21V 17/00

(52) U.S. Cl. 362/417

(57) ABSTRACT

An adjustable harp for use in supporting a shade on a lamp, wherein a sleeve is provided on said harp in a generally vertical attitude. A slot is formed in the sleeve with indentations in said slot and a lower leg is slidable in the sleeve to position a tang on the lower leg in a selected indentation to thereby determine the length of the harp.

The present invention relates generally to devices for supporting lamp shades and, more particularly, to an improved harp for that purpose.

### BACKGROUND OF THE INVENTION

1. Field of the Invention

As competition becomes more intense, efforts to find creative ways to accomplish well established goals is in great demand. So it is in the well established art of lamp construction.

Since time immemorial a device for holding a shade about a light bulb or like illuminating device, universally known as a harp by virtue of its shape, has been an integral element of a lamp. While harps vary only slightly in shape, they have, for years varied in size to accommodate the variance in size of the many shades that are available, so as to be in proportion to the lamp upon which they are married.

2. Overview of the Prior Art

There have been a large number of efforts to create a “one size fits all” harp. For example, Smurik U.S. Pat. No. 2,593,704 is of only limited interest in that it provides for finger pieces (22 and 22a), which are selectively pulled out to permit extension of the harp legs. The finger pieces have a stud which is movable in and out of slots.

The Pape et al. U.S. Pat. No. 6,971,773 uses a screw cap 39 which, when unscrewed permits the bottom portion 32 to be extended or retracted. When the leg is at the appropriate length, the screw cap returns to the slotted, tapered end in order to hold the leg in the designated position.

Hui U.S. Pat. No. 7,150,545 is a previous effort by the present inventor and, in no sense, could it be considered similar.

Auerbach U.S. Pat. No. 1,946,959 is a very early effort which uses screw caps and springs to secure the harp at the proper length.

Shoglow U.S. Pat. No. 2,895,041 uses an indentation 36 to secure the harp at the appropriate length.

Ewing U.S. Pat. No. 1,235,020 shows a shade holder having a series of upstanding rods which are mounted in support arms and held in a particular position by thumb screws.

While Ewing uses thumb screws which engage the rods and hold them frictionally, Lee, in his U.S. Pat. No. 5,412,554, accomplishes the same result by drilling screw holes in the rods and threading a set screw into one of those holes.

While accomplishing the same objectives as his forerunners, Leef, U.S. Pat. No. 2,408,522, uses yet another means of choosing and holding the position of the harp at a desired height.

Yet another method of positioning and holding the harp in a predetermined position is found in Auerbach U.S. Pat. No. 1,946,959. Auerbach cut notches in the legs and then uses what he calls “caps” to lock into the notches to hold the harp in place.

There are several others along the same general lines, among them, Berger reissue Pat. No. 20,170 and Pape et al. U.S. Pat. No. 6,971,773. Both of these patents appear to have issued because each uses a different means of securing the harp at the desired height.

### SUMMARY OF THE INVENTION

The present invention has, as its primary objective, the provision of a novel harp for use in a lighting fixture such as a lamp, which harp is fully adjustable to accommodate a variety of lamp shades of various sizes.

Another objective of the present invention is to provide the lighting industry with a harp for use with a lamp, which is a model of simplicity in construction, making it economical to make. It is yet another objective of the invention, related to the foregoing, to provide a harp which is surprisingly simple to adjust.

A further objective of the present invention is to provide a harp which is exceptionally stable once its size is established, and it is engaged with a lighting fixture.

The foregoing, as well as other objects and advantages of the present invention will occur to those skilled in the art upon a reading of the forthcoming Detailed Description of a Preferred Embodiment, taken in conjunction with the drawings, wherein:

### DESCRIPTION OF THE DRAWINGS

FIG. 1 is a pictorial representation of a harp for use in supporting a lamp shade on a lighting fixture, constructed in accordance with the present invention;

FIG. 2 is a front side elevation of the harp of FIG. 1;

FIG. 3 is a rear elevation of the harp of FIG. 1;

FIG. 4 is a top view of the harp of FIG. 2, looking down from the finial thereof, and with lower arms in locked position;

FIG. 5 is a portion of an upper leg of the harp of the present invention illustrating the extension mechanism thereof in its fully extended position;

FIG. 6 is a view similar to FIG. 1, except the harp is rotated 180 degrees;

FIG. 7 is a top plan view of the harp of FIG. 1;

FIG. 8 is a view similar to that of FIG. 5, with the lower leg fully retracted;

FIG. 9 is a view similar to FIG. 1, while illustrating the rotation and extension of the lower legs relative to the upper legs;

FIG. 10 is a side elevation, partially sectioned and showing how the lower leg appears as it is extended to increase the length of the harp;

FIG. 11 is view similar to FIG. 1, with the lower leg fully extended; and

FIG. 12 is a view similar to that of FIG. 8, with the lower leg fully extended.

### DETAILED DESCRIPTION OF A PREFERRED EMBODIMENT

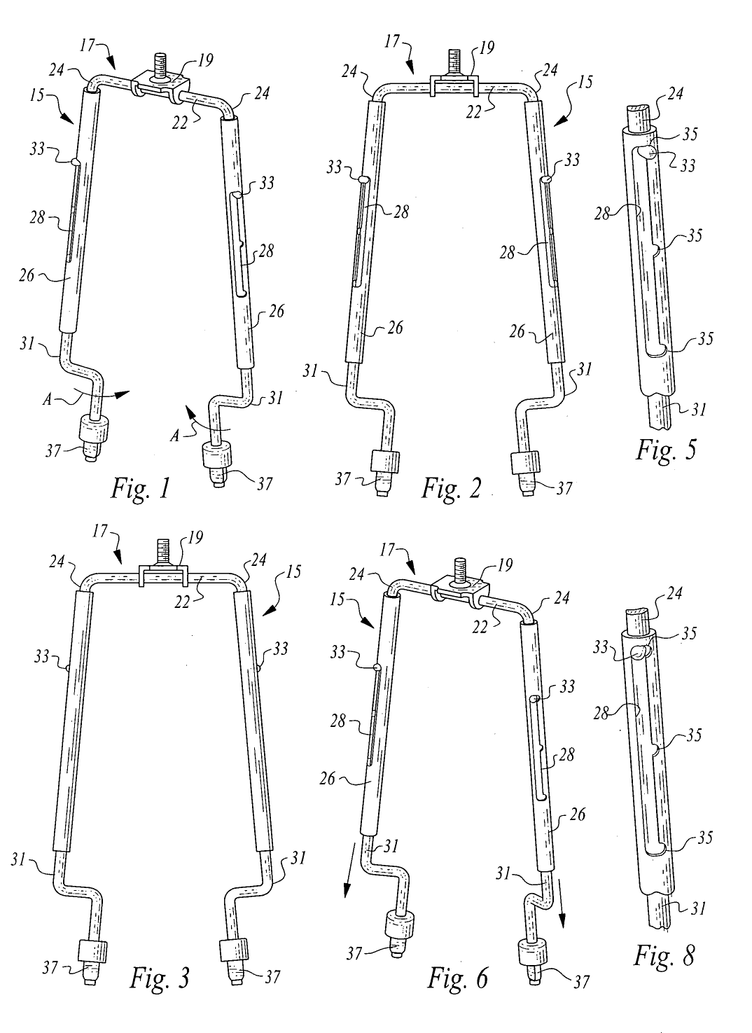

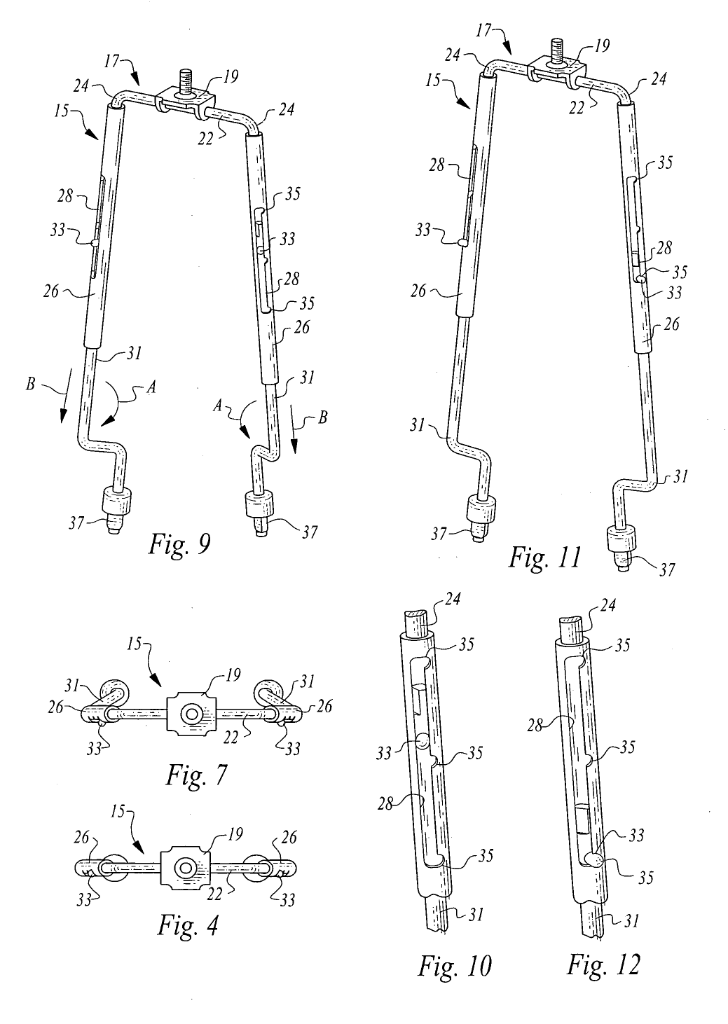

With reference now to the drawings, and initially to FIG. 1, an improved extensible harp 15 is illustrated. The harp 15 includes an inverted “U” shaped main frame 17 which supports a centrally located finial 19 on a laterally disposed cross member 22. Upper legs 24 depend from the cross member 22, and each is circumscribed by a longitudinally extending, elongated tubular sleeve 26, which is fixed to one of the upper legs.

Each sleeve 26 is formed, or otherwise provided, with an elongated, longitudinally extending slot 28 along the surface thereof, the purpose of which will quickly become apparent.

A pair of lower legs 31 are inserted in the tubular sleeves 26. The lower legs 31 are elongated and are both slidable and rotatable into the sleeve. Each lower leg is fixed with a tang 33 at or near an end of the lower leg which is inserted into the sleeve. The tang 33 is particularly sized to ride comfortably and snugly in the slot 28, the slot 28 itself is formed with at least one indentation 35. Three such indentations are illustrated and, preferably, axially aligned and spaced equidistant from adjacent ones of the indentations, although it will be appreciated that the precise number of such indentations may vary from one to several, depending on the length of the harp desired.

Referring now to FIGS. 1 and 9, the method of adjusting the size of the harp will be apparent. With the lower legs 31 initially inserted in their respective sleeves 26, the lower legs are then rotated so that the tang 33 is tightly disposed in a selected one of the indentations 35.

The longitudinal slot is specifically positioned on the sleeve 26 so that when the lower leg is positioned with the tang 33 in an indentation 35, the terminal ends 37 of the lower legs 31 are positioned at an exact distance apart and are aligned with a lamp shade support assembly [which is well known and, thus, not shown]. As is well known, [and therefor not depicted] virtually every lamp has a socket supported by a central post. The socket, of course, supports a bulb and the shade encircles the bulb. A shade support assembly includes a central post, including upstanding arms for the support of the shade assembly. The lower legs engage the upstanding arms and are supported thereby.

As is pointed out, with the tangs in an indentation, the lower legs are aligned with, and engageable with, the lower legs. One need only disengage the lower legs and, as the arrows A of FIG. 1 indicate, rotate the lower legs so that the tang on each is moved out of the indentation. In that attitude, the length of the lower leg may be adjusted [arrows B FIG. 9] to fit the length of the shade, and then rotated back into an appropriate indentation. The adjustment is accomplished without springs or detents. Rather, the process is manual and by means of a very positive inter engagement of parts.

While those skilled in the art will perceive some variation in the various elements of the novel harp, it will be understood that such variations are within the contemplation of the invention as defined by the following claims, wherein:

1. An adjustable harp;
said adjustable harp comprising a main frame, a pair of legs depending from said main frame;
a sleeve affixed to said legs and extending longitudinally therefrom, said sleeve having a slot formed therein, said slot having at least one indentation formed therein;
a pair of lower legs, each said lower leg having a tang formed at an upper end thereof, said tang being so sized as to fit conveniently and snugly in said indentation, said lower legs being slidable in said sleeve so as to position said tang in said indentation to thereby determine the length of said harp.

2. The adjustable harp of claim 1, wherein said slot is elongated and is longitudinally extending along a surface of said sleeve.

3. The adjustable harp of claim 2, wherein three indentations are provided.

4. The adjustable harp of claim 1, wherein several indentations are provided.

5. The adjustable harp of claim 1, wherein each said lower leg has a terminus.

6. The adjustable harp of claim 5, wherein the distance between said terminus of each of said lower legs is determined and exact, when each said tang is in a said indentation, in order that said harp may be fitted into a lamp shade support.

7. The adjustable harp of claim 2, wherein several indentations are provided.

8. The adjustable harp of claim 6, wherein three indentations are provided.

9. The adjustable harp of claim 6, wherein several indentations are provided.
